(19) United States
(12) Patent Application Publication
(10) Pub. No.: US 2023/0232865 A1
(43) Pub. Date: Jul. 27, 2023

(54) FEED SUPPLEMENTS FOR FEED FOR BROILER CHICKENS (VARIANTS), A METHOD FOR PRODUCING A FEED SUPPLEMENT FOR BROILER CHICKENS

(71) Applicant: DGP Technology Limited, Mahe, SC (US)

(72) Inventor: Thomas RIVIELLO, Gonzales, TX (US)

(21) Appl. No.: 17/585,861

(22) Filed: Jan. 27, 2022

(51) Int. Cl. A23K 50/75; A23K 20/28; A23K 20/111; A23K 20/121; A23K 40/00

(52) U.S. Cl. CPC A23K 50/75; A23K 20/28; A23K 20/111; A23K 20/121; A23K 40/00

(57) ABSTRACT

The group of inventions relates to feed supplements. The feed supplement for a feed product intended for broiler chickens includes, in the first variant, amorphous mesoporous silicon dioxide, solution of curcumin and rutin in polysorbate 80; in the second variant, amorphous mesoporous silicon dioxide, solution of curcumin in polysorbate 80, activated carbon; in the third variant, amorphous mesoporous silicon dioxide, solution of curcumin and rutin in polysorbate 80, activated carbon. The method for producing the feed supplement for a feed product intended for broiler chickens comprises loading amorphous silicon dioxide or amorphous silicon dioxide in a mixture with activated carbon into a disperser, stirring at from about 1000 rpm to about 2000 rpm for about 0.5 h while gradually adding micellated extract of curcumin in polysorbate 80 or micellated extract of curcumin and rutin in polysorbate 80, increasing the stirring speed to 7000 to 9000 rpm until a homogeneous product is generated. The group of inventions provides increased growth performance, improved quality of meat of broiler chickens. 4 independent claims, 7 subclaims, 8 tables.

The group of inventions relates to feed production, in particular to a feed product intended for broiler chickens.

Known is the use of curcumin, rutin, polysorbates in the medicine field.

For example, known is the anti-inflammatory effect of the composition of curcumin in combination with a mixture of tocopherols (CA 2595860 A1, claims section, claims 1,2).

Patent RU 2615815 C2 provides the use of emulsifiers: polysorbate 80, polysorbate 20, a mixture of polysorbate 20 and polysorbate 80 to produce a pharmaceutical formulation.

Known is a composition comprising curcumin, rutin, thioctic acid, said composition having antioxidant, immunomodulatory, anti-inflammatory effects (U.S. Ser. No. 10/980,791 B1).

The prior art does not provide the use of curcumin, rutin, polysorbate 80 in the production of feed supplements intended for broiler chickens.

Proposed is a group of inventions, which includes feed supplements for a feed product intended for broiler chickens and methods for producing thereof.

One variant of the feed supplement for a feed product intended for broiler chickens includes

amorphous mesoporous silicon dioxide: 64 wt %,

solution of curcumin and rutin in polysorbate 80: 36 wt %.

In a particular case, the size of mesopores of amorphous silicon dioxide is from 0.2 to 1.8 nm, and the solution of curcumin and rutin in polysorbate 80 has the following composition:

curcumin, 10.3 wt %,

rutin, 3 wt %,

polysorbate 80, balance.

Another variant of the feed supplement for a feed product intended for broiler chickens includes

amorphous mesoporous silicon dioxide: 44 wt %,

curcumin solution in polysorbate 80: 35 wt %,

activated carbon with pores of 100 nm or greater: 21 wt %.

In a particular case, the size of mesopores of amorphous silicon dioxide is from 0.2 to 1.8 nm, and the solution of curcumin in polysorbate 80 has the following composition:

curcumin, 10.3 wt %,

polysorbate 80, balance.

The third variant of the feed supplement for a feed product intended for broiler chickens includes

amorphous mesoporous silicon dioxide: 44 wt %,

solution of curcumin and rutin in polysorbate 80: 35 wt %,

activated carbon with pores from 100 nm: 21 wt %.

In a particular case, the size of mesopores of amorphous silicon dioxide is from 0.2 to 1.8 nm, and the solution of curcumin and rutin in polysorbate 80 has the following composition:

curcumin, 10.3 wt %,

rutin, 3 wt %,

polysorbate 80, balance.

The method for producing the feed supplement for a feed product intended for broiler chickens comprises loading amorphous silicon dioxide or amorphous silicon dioxide in a mixture with activated carbon into a disperser, stirring at from about 1000 rpm to about 2000 rpm for about 0.5 h while gradually adding micellated extract of curcumin in polysorbate 80 or micellated extract of curcumin and rutin in polysorbate 80, increasing the stirring speed to 7000 to 9000 rpm until a homogeneous product is generated.

The technical result is to increase growth performance, improve the quality of meat of broiler chickens.

The feed product used in conjunction with the present feed supplement can be formulated, for example, as follows.

The feed product comprises wheat, corn, soybean hulls, limestone, salt, vegetable oil, lysine monochlorohydrate, methionine, threonine, feather protein concentrate (FPC), semi-defatted soy, monocalcium phosphate, wheat bran, sodium sulfate, choline chloride.

It should be noted that the above feed is given as an example, the present feed supplements may be used with any other feed products for broiler chickens.

The feed supplements disclosed in the present group of inventions are suitable to be digested by broiler chickens, ensure complete digestion of feed in the stomachs of chickens, and the resulting residues are decomposed by pancreatic amylase when passing through the intestinal tracts and have a synergistic effect with intestinal microorganisms, enhancing the decomposition of feed residues, improving immunity and the quality of chicken meat. The feed supplement is environmentally friendly, safe, does not contain chemical residues, contaminants and does not induce toxic or side effects. The present feed supplement may significantly improve the growth and slaughter performance with regard to broiler chickens, contribute to growth of broiler chickens and improve the feed conversion rate, regulate the microecological balance of the intestines of broiler chickens, increase the antioxidant capacity and immune function of broiler chickens, increase the organism's immunity to diseases and resistance, lead to good economic benefits and facilitate healthy and rapid development of animal husbandry.

The supplements may be prepared as follows.

IKA T 50 digital disperser was loaded with Aerosil carrier and, while stirring at about 1000 rpm, micellated extract of curcumin in polysorbate 80 was gradually added for 0.5 hours, following adding the entire amount of extract, the mixing speed was increased to 7000 rpm at room temperature to increase the dispersibility and uniformity of the distribution of the substance. When the ratio was 55% to 45%, we obtained a yellow powder that was added to the basic ration compound feeds when stirred in a colloid mill.

IKA T 50 digital disperser was loaded with Aerosil carrier and, while stirring at about 1500 rpm, micellated extract of curcumin and rutin in polysorbate 80 was gradually added, following adding the entire amount of extract, the stirring speed was increased to 7000 rpm to increase the dispersibility and uniformity of the distribution of the substance. When the ratio was 64% to 36%, we obtained a yellow bulk product that was added to the basic ration of compound feeds when stirred in a colloid mill for a certain time.

In order to reduce the cost of the final product and reach an industrial scale, available carriers of active substrates, in particular amorphous silicon dioxide with a nanoporous particle structure and pharmacopoeia-grade activated carbon, were investigated and tested. Addition of silicon dioxide to broiler chicken rations is known to increase the gain in broiler chickens at the end of farming (42 days) by 5.4%, to reduce feed costs per 1 kg of body weight gain by 4.8%, to increase the livability of livestock by 4.9%, to reduce the content of heavy metals in muscle tissue homogenate, to positively effect the development of the intestinal microflora in broiler chickens and the economic performance of farming meat poultry.

IKA T 50 digital disperser was loaded with the carrier: amorphous silicon dioxide carrier with a mesopore size from 0.2 to 1.8 nm and, while stirring at about 1500 rpm, micellated extract of curcumin and rutin in polysorbate 80 (curcumin 10.3 wt %, rutin 3 wt %, the balance being polysorbate 80) was gradually added for 0.5 hours, following adding the entire amount of the extract, the stirring speed was increased to 8000 rpm in order to increase the dispersibility and uniformity of the distribution of the substance. When the ratio was 64 wt % to 36 wt %, we obtained a yellow bulk product that was included into the basic ration of compound feeds when stirred in a colloid mill.

The following experiment describes the preparation of a supplement, where activated carbon deposited with micellated curcumin acts as an additional carrier, as the literature provides that the introduction of activated carbons into the ration of broiler chickens contributes to the normalization of mean hemoglobin level in an erythrocyte. Biochemical studies show a tendency for the indicators of the functional state of the liver of broiler chickens to normalize, as well as the beneficial effect of an activated carbon feed supplement on mineral metabolism performance, which fact is most likely due to the ash residue of the supplement;

IKA T 50 digital disperser was loaded with amorphous silicon dioxide and pharmacopoeia-grade activated carbon; while stirring at about 2000 rpm, micellated extract of curcumin in polysorbate 80 was gradually added for 0.5 hours; following adding the entire amount of the extract, the stirring speed was increased to 9000 rpm to increase the dispersibility and uniformity of the distribution of the substance. 4.4 g of amorphous silicon dioxide (44 wt %), 3.5 g (35 wt %) of solution of curcumin in polysorbate 80 (curcumin 10.3 wt %, the balance being polysorbate 80) and 2.1 g of activated carbon (21 wt %) with pores of 100 nm and greater were used to prepare the supplement. When the ratio was 44% to 35% and 21%, we obtained a dark gray bulk product that was added to the basic ration of compound feeds when stirred in a colloid mill.

Another variant of the supplement can be prepared as follows.

IKA T 50 digital disperser was loaded with the carrier: amorphous silicon dioxide and pharmacopoeia-grade activated carbon (having the mesopore size from 0.2 to 1.8 nm); while stirring at about 1000 rpm, micellated extract of curcumin and rutin in polysorbate 80 was gradually added for 0.5 hours; following adding the entire amount of the extract, the stirring speed was increased to 7000 rpm to increase the dispersibility and uniformity of the distribution of the substance. 4.4 g of amorphous silicon dioxide (44 wt %), 3.5 g (35 wt %) of solution of curcumin and ruting in polysorbate 80 (curcumin 10.3 wt %, ruting 3 wt %, the balance being polysorbate 80) and 2.1 g of activated carbon (21 wt %) with pores of 100 nm and greater were used to prepare the supplement. When the ratio was 44% to 35% and 21%, we obtained a bulk product that was added to the basic ration of compound feeds when stirred in a colloid mill.

Zetasizer Nano analyzer was employed to analyse the sizes of nanoparticles of active substances on the absorbent of the prepared supplements (Table 1).

The graph (Table 1) shows that the initial form of curcumin in polysorbate 80 in the form of micelles (yellow) is superimposed on curcumin produced in the disperser (red) on an amorphous carrier, which fact directly indicates the applicability of this technology for producing nanopowders of active substances on absorbents and thus increasing the bioavailability of the test substrates.

Achievement of the technical result is confirmed by the tests that we conducted.

### STUDY MATERIAL AND PROCEDURE

The study employed broiler chickens of “Foxy Chick” breed aged one day to 35 days under vivarium conditions. The groups were formed by analog method without gender separation, each group included 35 animal units. Feeding was carried out with dry all-in-one crumbled compound feeds with nutritional value according to the norms, ad libitum. Supplements of biologically active substances in a crumbly form served as the material for the study.

The first group received a basic ration comprising 107.56 kg of compound feed per group, without feed supplements.

The second group received 107.38 kg of compound feed plus 0.25 kg of supplements in powder form having the following composition: mesoporous silicon dioxide, curcumin, rutin, in polysorbate 80. The mixture was processed in a colloid mill and then fed to the chickens.

The third group received 107.28 kg of feed plus 0.45 kg of supplements in powder form having the following composition: mesoporous silicon dioxide and curcumin in polysorbate 80, activated carbon with pores of 100 nm or greater. The mixture was processed in a colloid mill and then fed to the chickens.

The fourth group received 107.31 kg of compound feed and 0.45 kg of supplements in powder form comprising: mesoporous silicon dioxide, activated carbon with pores of 100 nm or greater, curcumin and rutin in polysorbate 80.

The whole composition was processed in a colloid dry grinding mill and then fed to chickens.

Until aged 3 days, chickens from all groups received granular feed, then crumbled compound feeds of the same nutritional value, the recipe of the latter is shown in Table 2.

Physiological experiments to determine the digestibility and availability of nutrients in the ration, as well as the use of calcium and phosphorus from compound feeds by broilers following including nanocurcumin and nanocurcumin+rutin supplements into feed were carried out on male chickens (n=3) aged 30-34 days.

The digital data obtained in the experiments were processed by variation statistics according to Student's test. The data in the tables are given as M±m, where M is the arithmetic mean, m is the arithmetic mean error. The differences were considered significant if p<0.05. The study took into account the livability of livestock (%) by taking into account mortality and determining causes thereof. Broiler body weight was determined at the age of 7-21 days and at the end of the experiment by individual weighing of the entire livestock and by weighing in groups, in grams. Feed consumption per head and per kg of body weight gain for the period of the study was determined by daily recording of feed throughout the groups. The chemical and amino acid composition of broiler meat (leg and pectoral muscles) was also determined.

Study Results.

The zootechnical results of studies on the effect of compound feed supplements nanocurcumin and nanocurcumin+rutin on the carrier for broiler chickens are shown in Table 3.

Table 3 shows that the body weight of 7-day-old chickens from experimental group 3 which received nanocurcumin was 1.59% greater than that of control. By the age of 21 days, the broilers from this group exceeded the control analogues by 4.6% in terms of body weight (the difference was statistically significant if p≥0.05), and by the end of farming, the mean body weight of chickens from the group was 4.02% great than that of control. Further, the body weight of male chickens was 2.0% greater than that of control, and that of female chickens was 6.4% greater than that of control, the difference in relation to control is significant. Good digestibility of the nanokurkmin+rutin supplement contributed to an improvement in feed conversion in broilers from experimental group 3 as compared to that of control by 7.02%, an increase in the mean daily gain in body weight by 4.06%, which fact had an effect on an increase in the broiler production index by 41.92 points as compared to that of control. That is, the body weight of chickens from group 4 aged 7; 21 and 35 days was significantly greater than that of control by 2.0; 7.8 and 7.2%. Further, the body weight of male chickens was significantly greater than that in the control group by 6.2%, and that of female chickens was greater by 8.4%. Use of the micellated form of nanocurcumin on the carrier had a positive effect on feed conversion ratio and contributed to a decrease in this indicator by 11.7%. Comprehensive assessment of broiler production efficiency according to the production index showed that the inclusion of the micellated form of nanocurcumin on absorbent into the compound feed for broilers from experimental group 4 provided an increase in the production index of chickens from the above group by 70.83 points as compared to that of control.

The data of digestion trial shown in Table 5 are consistent with the zootechnical results obtained. It was found that the increase in the growth rate of chickens from experimental group 3 is due to an improvement in the digestibility and availability of nutrients from compound feeds. That is, the digestibility of protein, feed dry matter, fat, fiber was improved by 1.55%; 1.61; 1.75; 1.4% in comparison with those of control, and use of nitrogen, phosphorus and availability of lysine and methionine was improved by 8.58; 3.3 and 1.06; 0.83%. Further, use of calcium was at a level of the corresponding indicators of control group.

Table 4 shows use of feed nutrients (%) by broilers aged 30-35 days, M±m, n=3.

When assessing the effect of nanocurcumin+rutin supplements on a carrier at 250 g/t of feed on the digestibility and availability of feed nutrients, it should be noted that broilers from experimental group 4 showed greater results in terms of digestibility of protein, feed dry matter, fat, fiber as compared to those of control analogues by 1.86; 1.95; 3.55; 2.6%, and use of nitrogen, calcium, phosphorus and availability of lysine and methionine was improved as compared to control by 8.34; 0.95; 3.9; 1.66 and 2.73.

Table 5 shows the chemical composition (%) and the content of vitamins and carotenoids (μg/g) in the liver of broiler chickens aged 36 days.

Analysis of the chemical composition of the liver of 35-day-old broilers showed (Table 5) that the protein content in the liver of chickens from groups 2, 3 and 4 was greater than that of control by 5.37; 8.17 and 8.05%; further, there was observed a decrease in the fat content in the liver of broilers which received both nanocurcumin+rutin preparation and nanocurcumin preparation by 2.76; 7.31 and 7.71%, which fact indirectly indicates the absence of cytotoxic effect onto liver cells as a result of the use of applied preparations in the dosages studied.

The content of vitamin B2 in the liver of broilers practically did not differ within the groups and was in the range of 11.38 to 11.74 μg/g.

Table 6 shows biochemical and hematological blood parameters in 35-day-old broiler chickens (n=3).

The study of hematological and biochemical parameters in broilers showed (Table 6) that the level of total protein, leukocyte formula, the content of erythrocytes in chickens from all groups practically did not differ and was within the physiological norm for the given chicken age. That is, the protein level was in the range of 37.7 to 42.9 g/l, the concentration of erythrocytes was 2.8 to 3.0 RBC*10¹²/I. Further, the cholesterol and uric acid levels in the experimental groups were statistically significantly lower than those in the control group chickens (p≤0.001) with a greater level of hemoglobin, which was 140.7 to 152.0 in the experimental groups and 124.3 in the chickens from the control group.

Results of the analysis of chemical and amino acid composition of broiler meat (pectoral and leg muscles) shown in Tables 7 and 8 showed that the inclusion of an additional source of nanocurcumin and rutin taken as supplements into the rations of broilers from groups 2 and 3 contributed to an increase in protein content in the pectoral muscles of male chickens by 3.2 and 4.06% due to a decrease in fat content by 3.44 and 3.35% and an increase in the amount of amino acids as compared to control by 2.53 and 2.73%. Content of essential amino acids in pectoral muscles of chickens from groups 2 and 3 was greater as compared to that of control by 0.9 and 0.89%.

There was also observed a greater content of protein, essential amino acids in pectoral muscles of chickens from groups 2 and 3 by 1.24; 1.13% and 1.78; 1.73%, with decreased fat content by 0.01 and 0.14%.

Nanocurcumin supplements for broilers from experimental group 4 contributed to improved meat quality. Protein content in the pectoral muscles of male and female chickens increased by 2.33 and 1.45% as compared to that of control, essential amino acid content increased by 1.89 and 1.33% with decreased fat content by 1.36% in male chickens and by 0.99% in female chickens from group 4.

Analysis of chemical composition of leg muscles of broilers showed that broilers from experimental groups 2 and 3 which received nanocurcumin+rutin had a lower fat content (by 2.16 and 3.55% in male chickens and by 9.66 and 10.13% in female chickens). Protein content in leg muscles of male chickens was greater as compared to that of control by 1.92 and 2.02%, and that in female chickens was greater by 6.76 and 7.98% as compared to that of control. Content of essential amino acids in leg muscles of broilers from experimental groups 2 and 3 was greater as compared to that of control by 0.93 and 1.25% in male chickens and by 3.18 and 3.4% in female chickens.

Use of a nanoscale form of curcumin had a positive effect on increasing the protein content in leg muscles of male and female chickens from experimental group 4 by 2.53 and 8.21%, which was due to a decrease in fat content by 4.49% in male chickens and 23.12% in female chickens.

Analysis of chilled broiler meat (pectoral and leg muscles) for the peroxide value showed that the peroxide value % I in chickens from groups 2, 3 and 4 was 0.026; 0.038 and 0.049 versus 0.042% I in meat of broilers from the control group.

Tasting assessment revealed no differences in taste qualities of meat and broth between the control and experimental groups.

Thus, taking into account, inter alia, the data of the above studies, it was found that the high availability of biologically active substances from the above supplements has a positive effect on the production efficiency of broiler chickens, providing an increase in the body weight of broilers by 4.03 to 7.4%, reduction in feed costs per 1 kg of body weight gain by 7.62 to 10.9%, improvement in vitamin supply to chickens.

Hepatoprotective properties of supplements contribute to improved functional condition of liver by means of reducing fat levels by 9.3, 13.15 and 12.89%. Further, the cholesterol and uric acid levels in the experimental groups were statistically significantly lower than those in the control group chickens (p≤0.001) with a greater level of hemoglobin, which was 140.7 to 152.0 in the experimental groups and 124.3 in the chickens from the control group. Positive effect of supplements on intensity of protein, carbohydrate and lipid metabolism contributes to increased protein content in pectoral and leg muscles of broilers due to reduced fat content, which fact may contribute to increased shelf life of meat as a result of reduced level of free radicals formed during meat storage.

TABLE 2
Composition and nutritional value of compound
feed of control group %

| Component | 3-21 days | 22-34 days |
|---|---|---|
| Wheat | 56.10 | 56.23 |
| Soy meal | 20.0 | 33.0 |
| Limestone | 4.0 | 2.6 |
| Sodium chloride | 0.12 | 0.18 |
| Vegetable oil | 3.2 | 4.1 |
| Lysine | 0.11 | 0.15 |
| Methionine | 0.2 | 0.32 |
| Threonine | 0.17 | 0.24 |
| Soy | 1.1 | 1.5 |
| Bran | 2.4 | 3.0 |
| Choline chloride | 0.18 | 2.2 |
| Sodium sulfate | 1.4 | 1.5 |

TABLE 3
Main zootechnical results of the experiment on broilers

| | Group | | | |
|---|---|---|---|---|
| Indicator | 1(c) | 2 | 3 | 4 |
| Livability of | 100 | 100 | 100 | 100 |
| livestock, % | | | | |
| Body weight, g, | | | | |
| at age, days: | | | | |
| daily | 42.0 ± | 42.3 ± | 42.2 ± | 42.0 ± |
| | 0.34 | 0.41 | 0.39 | 0.34 |
| 7 | 169.3 ± | 166.23 ± | 172.0 ± | 175.80 ± |
| | 2.24 | 2.44 | 2.1 + | 2.02 + |
| | | | 1.59% | 2.0% |
| 21 | 839.11 ± | 859.94 ± | 877.71 ± | 904.31 ± |
| | 12.17 | 13.53 + | 14.51¹ + | 14.45³ + |
| | | 2.5% | 4.6% | 7.8% |
| 35 (average) | 1993.3 | 2022.4 + | 2073.48 + | 2136.74 + |
| | | 1.46% | 4.02% | 7.2% |
| including: | | | | |
| male chickens | 2175.80 ± | 2160.14 ± | 2220.40 ± | 2311.31 ± |
| | 39.40 | 19.99 − | 56.63 + | 53.791 + |
| | | 0.7% | 2.0% | 6.2% |
| female chickens | 1810.80 ± | 1884.65 ± | 1926.55 ± | 1962.17 ± |
| | 33.28 | 23.21 + | 35.02¹ + | 38.532 + |
| | | 4.08% | 6.4% | 8.4% |
| Feed | 3.071 | 3.069 | 3.066 | 3.067 |
| consumption | | | | |
| per head, kg | | | | |
| Feed | 1.639 | 1.569 | 1.524 | 1.464 |
| consumption | | | | |
| per 1 kg of body | | | | |
| weight gain, kg | | | | |
| Mean daily | 57.38 | 58.24 | 59.74 | 61.61 |
| body weight | | | | |
| gain, g | | | | |
| Economical | 349.98 | 371.19 | 391.90 | 420.8 |
| efficiency | | | | |
| index, point | | | | |

TABLE 4
Use of feed nutrients (%) by broilers aged 30-35 days. M ± m, n = 3.

| | Group | | | |
|---|---|---|---|---|
| Indicator | 1(c) | 2 | 3 | 4 |
| Digestibility: | | | | |
| protein | 93.72 ± 0.4 | 92.9 ± 0.4 | 95.27 ± 0.47 | 95.58 ± 0.47 |
| feed dry matter | 74.63 ± 0.3 | 76.26 ± 0.3 | 76.24 ± 0.40 | 76.58 ± 0.40 |
| fat | 84.90 ± 0.3 | 84.80 ± 0.4 | 86.65 ± 0.44 | 88.40 ± 0.44 |
| fiber | 18.3 ± 0.8 | 18.2 ± 0.8 | 19.7 ± 0.79 | 20.90 ± 0.79 |
| Use: | | | | |
| nitrogen | 60.66 ± 0.3 | 67.50 ± 0.3 | 69.25 ± 0.27 | 69.0 ± 0.27 |
| calcium | 48.9 ± 0.2 | 48.75 ± 0.2 | 48.34 ± 0.20 | 49.85 ± 0.20 |
| phosphorus | 32.6 ± 0.1 | 32.7 ± 0.1 | 35.9 ± 0.12 | 36.50 ± 0.12 |
| Availability: | | | | |
| lysine | 88.0 ± 0.5 | 89.71 ± 0.4 | 89.06 ± 0.44 | 89.66 ± 0.45 |
| methionine | 84.21 ± 0.4 | 86.40 ± 0.5 | 85.04 ± 0.39 | 86.94 ± 0.40 |

TABLE 5
Chemical composition (%) and the content of vitamins and carotenoids
(μg/g) in the liver of broiler chickens aged 36 days.

| | Group | | | |
|---|---|---|---|---|
| Indicator | 1(c) | 2 | 3 | 4 |
| Moisture | 65.61 | 68.84 | 70.89 | 67.79 |
| Crude protein | 58.81 | 64.18 | 66.98 | 66.86 |
| Crude fat | 23.38 | 20.62 | 16.07 | 15.67 |
| Crude ash | 4.05 | 4.45 | 4.64 | 4.62 |
| Vitamin A | 135.23 | 158.40 | 170.39 | 179.15 |
| Vitamin E | 14.71 | 15.19 | 17.53 | 17.59 |
| Vitamin B2 | 11.74 | 11.54 | 11.38 | 11.70 |
| Carotenoids | 0.49 | 0.43 | 0.69 | 0.77 |

TABLE 6
Biochemical and hematological blood parameters in 35-day-old broiler
chickens (n = 3).

| | Group | | | |
|---|---|---|---|---|
| Indicator | 1(c) | 2 | 3 | 4 |
| Total protein, g/l | 38.90 ± 0.78 | 37.7 ± 0.57 | 42.9 ± 3.06 | 40.0 ± 1.50 |
| Trypsin, units/l | 497.9 ± 59.3 | 378.4 ± 26.28 | 586.1 ± 35.69 | 519.9 ± 35.69 |
| Glucose, mmol/1 | 14.8 ± 0.26 | 13.9 ± 0.05 | 12.6 ± 1.42 | 12.8 ± 0.47 |
| Cholesterol, | 2.15 ± 0.07 | 1.76 ± 0.029*** | 1.89 ± 0.19*** | 1.83 ± 0.10*** |
| mmol/1 | | | | |
| Uric acid, | 359.1 ± 18.82 | 283.3 ± 7.92** | 256.6 ± 18.70*** | 222.3 ± 17.2 |
| mmol/1 | | | | |
| ALT, units/l | 41.4 ± 6.43 | 49.3 ± 5.77 | 36.1 ± 1.35 | 30.1 ± 0.63 |
| AST, units/l | 351.7 ± 1.34 | 348.9 ± 17.13 | 392.0 ± 11.19 | 401.0 ± 52.57 |
| Alkaline | 10219.8 ± 2246 | 14722 ± 2199 | 10932 ± 1773 | 10932 ± 1773 |
| phosphatase, | | | | |
| units/l | | | | |
| White blood cells | 35.8 ± 2.36 | 31.3 ± 1.60 | 38.2 ± 2.99 | 32.8 ± 0.70 |
| WBC*10 ⁹/l | | | | |
| Pseudoeosinophils, | 36.5 ± 1.02 | 43.5 ± 6.06 | 55.5 ± 1.76 | 45.7 ± 4.19 |
| % | | | | |
| Lymphocytes, % | 56.7 ± 1.90 | 51.7 ± 4.74 | 31.6 ± 5.10 | 45.6 ± 5.43 |
| Monocytes, % | 0.3 ± 0.09 | 0.4 ± 0.07 | 3.6 ± 2.93 | 0.40 ± 0.10 |
| Eosinophils, % | 6.0 ± 1.03 | 4.2 ± 1.42 | 9.0 ± 2.78 | 8.0 ± 1.10 |
| Basophils, % | 0.4 ± 0.15 | 0.3 ± 0.09 | 0.2 ± 0.09 | 0.3 ± 0.09 |
| Red blood cells, | 2.9 ± 0.12 | 2.8 ± 0.10 | 3.0 ± 0.09 | 3.0 ± 0.01 |
| rbc*10¹²/l | | | | |
| Hemoglobin, g/l | 124.3 ± 6.77 | 140.7 ± 4.8 | 152.0 ± 3.51 | 146.3 ± 0.88 |
| Hematocrit, % | 37.0 ± 1.60 | 35.5 ± 1.29 | 38.3 ± 0.66 | 37.3 ± 0.30 |

**p < 0.01;
***p < 0.001

TABLE 7
Chemical composition and content of amino acids in the homogenate
of pectoral muscles of broilers, (% of air dry matter)

| | male chickens | | | | female chickens | | | |
|---|---|---|---|---|---|---|---|---|
| | Group | | | | | | | |
| Indicator | 1(c) | 2 | 3 | 4 | 1(c) | 2 | 3 | 4 |
| Moisture | 69.50 | 69.20 | 71.40 | 70.35 | 73.61 | 71.17 | 66.86 | 69.25 |
| Crude protein | 85.60 | 88.80 | 89.66 | 87.93 | 88.23 | 89.47 | 89.36 | 89.68 |
| Crude fat | 6.61 | 3.17 | 3.26 | 5.25 | 3.60 | 3.59 | 3.45 | 2.61 |
| Crude ash | 4.42 | 4.66 | 4.47 | 4.43 | 4.40 | 4.53 | 4.51 | 4.65 |
| Lysine | 7.51 | 7.74 | 7.76 | 7.62 | 7.45 | 7.65 | 7.67 | 7.60 |
| Valine | 4.39 | 4.49 | 4.39 | 4.49 | 4.26 | 4.45 | 4.48 | 4.30 |
| Methionine | 2.24 | 2.35 | 2.39 | 2.34 | 2.33 | 2.33 | 2.34 | 2.34 |
| Isoleucine | 4.09 | 4.20 | 4.21 | 4.20 | 4.07 | 4.18 | 4.12 | 4.08 |
| Leucine | 6.61 | 6.76 | 6.78 | 6.65 | 6.57 | 6.74 | 6.69 | 6.70 |
| Threonine | 3.65 | 3.81 | 3.82 | 3.79 | 3.73 | 3.77 | 3.78 | 3.74 |
| Phenylalanine | 3.40 | 3.44 | 3.43 | 3.42 | 3.34 | 4.41 | 4.40 | 4.32 |
| Σ essential | 31.89 | 32.79 | 32.78 | 32.51 | 31.75 | 33.53 | 33.48 | 33.08 |
| amino acids | | | | | | | | |
| Alanine | 4.88 | 5.02 | 4.92 | 4.91 | 4.85 | 4.98 | 4.99 | 4.92 |
| Cystine | 0.97 | 0.99 | 0.98 | 0.98 | 0.98 | 0.98 | 1.0 | 1.1 |
| Histidine | 3.09 | 3.07 | 3.08 | 3.10 | 3.12 | 2.98 | 3.14 | 3.15 |
| Arginine | 5.51 | 5.53 | 5.55 | 5.54 | 5.41 | 5.44 | 5.46 | 5.42 |
| Aspartic acid | 7.70 | 7.96 | 7.93 | 7.95 | 7.70 | 7.73 | 7.73 | 7.72 |
| Tyrosine | 2.91 | 3.01 | 2.98 | 2.95 | 2.94 | 2.91 | 2.95 | 2.95 |
| Serine | 3.05 | 3.29 | 3.28 | 3.20 | 3.20 | 3.21 | 3.20 | 3.21 |
| Glutamic acid | 11.83 | 12.47 | 12.83 | 12.95 | 12.05 | 12.26 | 12.27 | 12.28 |
| Proline | 2.95 | 3.01 | 3.04 | 3.03 | 2.93 | 3.01 | 3.05 | 3.01 |
| Glycine | 3.55 | 3.72 | 3.69 | 3.72 | 3.55 | 3.57 | 3.58 | 3.65 |
| Σ nonessential | 46.44 | 48.07 | 48.28 | 48.33 | 46.73 | 47.07 | 47.37 | 47.41 |
| amino acids | | | | | | | | |
| Total | 78.33 | 80.86 | 81.06 | 80.84 | 78.48 | 80.60 | 80.85 | 80.49 |
| aminoacids | | | | | | | | |

TABLE 8
Chemical composition and content of amino acids in the homogenate
of leg muscles of broilers, (% of air dry matter)

| | male chickens | | | | female chickens | | | |
|---|---|---|---|---|---|---|---|---|
| | Group | | | | | | | |
| Indicator | 1(c) | 2 | 3 | 4 | 1(c) | 2 | 3 | 4 |
| Moisture | 67.47 | 67.42 | 65.16 | 62.59 | 64.01 | 70.08 | 67.12 | 67.24 |
| Crude | 66.99 | 68.91 | 69.01 | 69.52 | 60.83 | 67.59 | 68.81 | 69.04 |
| protein | | | | | | | | |
| Crude fat | 27.66 | 25.50 | 24.11 | 23.17 | 34.21 | 24.55 | 24.08 | 23.12 |
| Crude ash | 3.71 | 3.84 | 3.44 | 3.23 | 3.28 | 3.90 | 3.57 | 3.56 |
| Lysine | 5.19 | 5.49 | 5.65 | 5.91 | 4.87 | 5.57 | 5.18 | 5.66 |
| Valine | 3.19 | 3.31 | 3.34 | 3.39 | 2.98 | 3.33 | 3.36 | 3.53 |
| Methionine | 1.84 | 1.87 | 1.89 | 1.85 | 1.76 | 1.96 | 1.99 | 1.98 |
| Isoleucine | 3.05 | 3.14 | 3.32 | 3.78 | 2.81 | 3.22 | 3.22 | 3.33 |
| Leucine | 4.90 | 5.07 | 5.05 | 5.08 | 4.45 | 5.16 | 5.94 | 5.94 |
| Threonine | 2.76 | 2.87 | 2.84 | 2.69 | 2.48 | 2.90 | 2.75 | 2.83 |
| Phenylalanine | 2.53 | 2.64 | 2.62 | 2.42 | 2.29 | 2.68 | 2.60 | 2.65 |
| Σ | 23.46 | 24.39 | 24.71 | 25.12 | 21.64 | 24.82 | 25.04 | 25.92 |
| Alanine | 3.78 | 4.04 | 4.08 | 4.53 | 3.57 | 4.04 | 4.58 | 4.66 |
| Cystine | 0.73 | 0.74 | 0.75 | 0.67 | 0.66 | 0.78 | 0.79 | 0.78 |
| Histidine | 2.23 | 2.24 | 2.26 | 2.14 | 2.05 | 2.25 | 2.25 | 2.13 |
| Arginine | 3.75 | 4.04 | 3.78 | 3.67 | 3.53 | 4.03 | 4.15 | 3.59 |
| Aspartic | 5.55 | 5.82 | 5.64 | 5.21 | 5.14 | 5.89 | 5.94 | 5.84 |
| acid | | | | | | | | |
| Tyrosine | 2.12 | 2.22 | 2.25 | 2.04 | 1.94 | 2.27 | 2.29 | 2.29 |
| Serine | 2.38 | 2.49 | 2.42 | 2.41 | 2.12 | 2.46 | 2.16 | 2.30 |
| Glutamic | 9.16 | 9.69 | 9.41 | 9.73 | 8.11 | 9.61 | 9.78 | 9.67 |
| acid | | | | | | | | |
| Proline | 2.62 | 2.76 | 2.74 | 2.67 | 2.42 | 2.67 | 2.74 | 2.81 |
| Glycine | 3.12 | 3.41 | 3.86 | 3.81 | 2.87 | 3.19 | 3.31 | 3.95 |
| Σ | 32.32 | 37.45 | 37.22 | 36.88 | 32.41 | 37.19 | 37.99 | 38.02 |
| Total | 55.78 | 61.84 | 61.90 | 62.0 | 54.05 | 62.01 | 63.03 | 63.94 |
| aminoacids | | | | | | | | |

1. A feed supplement for feed for broiler chickens, comprising
amorphous mesoporous silicon dioxide: 64 wt %,
solution of curcumin and rutin in polysorbate 80: 36 wt %.

2. The feed supplement as claimed in claim 1, characterized in that the mesopore size of amorphous silicon dioxide is from 0.2 to 1.8 nm, and the solution of curcumin and rutin in polysorbate 80 has the following composition:
curcumin, 10.3 wt %,
rutin, 3 wt %,
polysorbate 80, balance.

3. A feed supplement for feed for broiler chickens, comprising
amorphous mesoporous silicon dioxide: 44 wt %,
curcumin solution in polysorbate 80: 35 wt %,
activated carbon with pores of 100 nm or greater: 21 wt %.

4. The feed supplement as claimed in claim 1, characterized in that the mesopore size of amorphous silicon dioxide is from 0.2 to 1.8 nm, and the solution of curcumin in polysorbate 80 has the following composition:
curcumin, 10.3 wt %,
polysorbate 80, balance.

5. A feed supplement for feed for broiler chickens, comprising
amorphous mesoporous silicon dioxide: 44 wt %,
solution of curcumin and rutin in polysorbate 80: 35 wt %,
activated carbon with pores from 100 nm: 21 wt %.

6. The feed supplement as claimed in claim 5, characterized in that the mesopore size of amorphous silicon dioxide is from 0.2 to 1.8 nm, and the solution of curcumin and rutin in polysorbate 80 has the following composition:
curcumin, 10.3 wt %,
rutin, 3 wt %,
polysorbate 80, balance.

7. A method for producing a feed supplement for feed for broiler chickens comprising loading amorphous silicon dioxide or amorphous mesoporous silicon dioxide in a mixture with activated carbon into a disperser, stirring at from about 1000 rpm to about 2000 rpm for about 0.5 h while gradually adding micellated extract of curcumin in polysorbate 80 or micellated extract of curcumin and rutin in polysorbate 80, increasing the stirring speed to 7000 to 9000 rpm until a homogeneous product is generated.

8. The method for producing a feed supplement as claimed in claim 7, characterized in that the mesopore size of amorphous silicon dioxide is from 0.2 to 1.8 nm.

9. The method for producing a feed supplement as claimed in claim 7, characterized in that the activated carbon includes pores with a diameter of 100 nm or more.

10. The method for producing a feed supplement as claimed in claim 7, characterized in that the solution of curcumin and rutin in polysorbate 80 has the following composition:
curcumin, 10.3 wt %,
rutin, 3 wt %,
polysorbate 80, balance.

11. The method for producing a feed supplement as claimed in claim 7, characterized in that the solution of curcumin in polysorbate 80 has the following composition:
curcumin, 10.3 wt %,
polysorbate 80, balance.
